(19) United States
(12) Patent Application Publication
(10) Pub. No.: US 2007/0013594 A1
(43) Pub. Date: Jan. 18, 2007

(54) Article carrier antenna

(76) Inventors: Korkut Yegin, Grand Blanc, MI (US); William R. Livengood, Grand Blanc, MI (US); Steven V. Byrne, Burton, MI (US); Stephen D. Scott, Fenton, MI (US); Daniel G. Morris, Ovid, MI (US)

Correspondence Address: DELPHI TECHNOLOGIES, INC., M/C 480-410-202, PO BOX 5052, TROY, MI, 48007, US

(21) Appl. No.: 11/179,885

(22) Filed: Jul. 12, 2005

(51) Int. Cl. H01Q 1/32

(52) U.S. Cl. 343/713; 343/711

(57) ABSTRACT

A hidden antenna system is disclosed. The hidden antenna system includes an external vehicle component, such as, an article carrier. The article carrier includes a removable portion attached to a fixed portion that defines a cavity. An antenna element is housed within the cavity in the article carrier. According to an embodiment, an end cap structure that elevates and supports a side rail over a vehicle roof includes the removeable portion and fixed portion. According to an embodiment, the article carrier includes a first and second cavity that houses a first and second antenna element, respectively, within the first and second cavities, such that the at least two antennta elements operate in a diversity application.

### FIELD

The invention relates to article carriers. More particularly, the invention relates to an article carrier including an antenna element.

### BACKGROUND

Article carriers, which are also referred to in the art as roof racks or luggage carriers, are typically mounted over an outer surface of a vehicle, such as a roof portion or trunk deck lid. The article carrier typically includes at least one side rail and/or cross rail, which may be formed of any desirable material, such as a plastic material or metallic material. The primary function of an article carrier is to increase the storage capacity of a vehicle by allowing items to be stored over a vehicle's outer surface.

Due to the optimal radiating location on the roof portion or trunk deck lid, article carriers have also been utilized to function as, or, provide support for an antenna or antenna assembly. A known article carrier, which is described in U.S. Pat. No. 4,535,336 to Shaver, is shown generally at 100 in FIGS. 5 and 6. The article carrier 100 includes front and rear cross rails 102, 104, and left and right side rails 106, 108 that are supported by stanchions 110, which are secured to a vehicle roof portion 112 by sheet metal screws 114 and plastic bushings (not shown). A television transformer 116 is connected to the cross rails 102, 104 and side rails 106, 108 with conductive leads 118 by screws 120. In operation, the article carrier 100 functions as a dipole antenna for reception of television signals.

Another known article carrier, which is described in U.S. Pat. No. 5,629,712 to Adrian et al., is shown generally at 200 in FIG. 7. The article carrier 200 is shown to include a cross rail 202 and a sheet metal roof portion 204. The sheet metal roof portion 204 provides a ground plane. The cross rail 202 conceals a conducting loop antenna 206. Concealed in the roof portion 204 is a coaxial cable 208 that is connected to the conducting loop antenna 206. In operation, the article carrier 200 functions as a dual FM slot and AM monopole antenna.

Although adequate in receiving television signals, AM signals, and FM signals, the article carriers 100, 200 include a plurality of structural components and associated manufacturing steps that increase cost while making serviceability of the article carrier 100, 200 more complex and time consuming. Even further, known article carriers do not provide an antenna element or antenna assembly for reception of higher frequency signals, such as, for example, signals relating to personal communication systems/advanced mobile phone service (PCS/AMPS), global positioning systems (GPS), satellite digital audio radio services (SDARS), and the like.

A need therefore exists for an improved article carrier that provides reception for higher frequency signals, functions as a concealing element for an antenna element, and maintains eye-pleasing vehicle aesthetics and antenna performance.

### BRIEF DESCRIPTION OF THE DRAWINGS

The inventors of the present invention have recognized these and other problems associated with article carriers. The present invention will now be described, by way of example, with reference to the accompanying drawings, in which:

FIG. 1 is a top perspective view of an article carrier according to an embodiment;

FIG. 2 is an exploded view of the article carrier according to FIG. 1;

FIG. 3 is a perspective view of an antenna element according to an embodiment that is concealed by the article carrier of FIG. 1;

FIG. 4 is an exploded view of the antenna element according to FIG. 3;

FIG. 5 is a perspective view of a conventional article carrier including an antenna;

FIG. 6 is a magnified view of the conventional article carrier of FIG. 5; and

FIG. 7 is a perspective view of another conventional article carrier including an antenna.

### DESCRIPTION

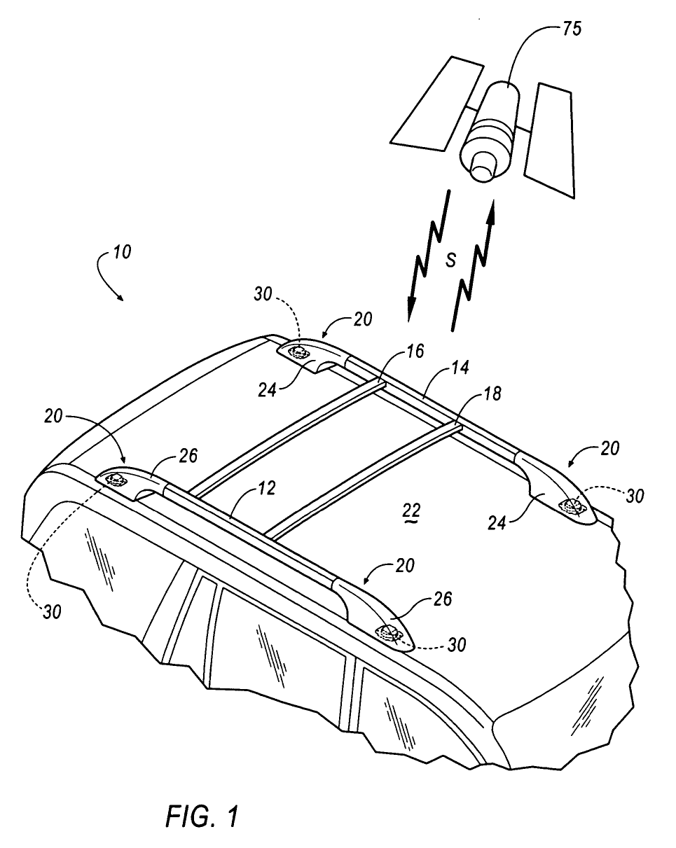

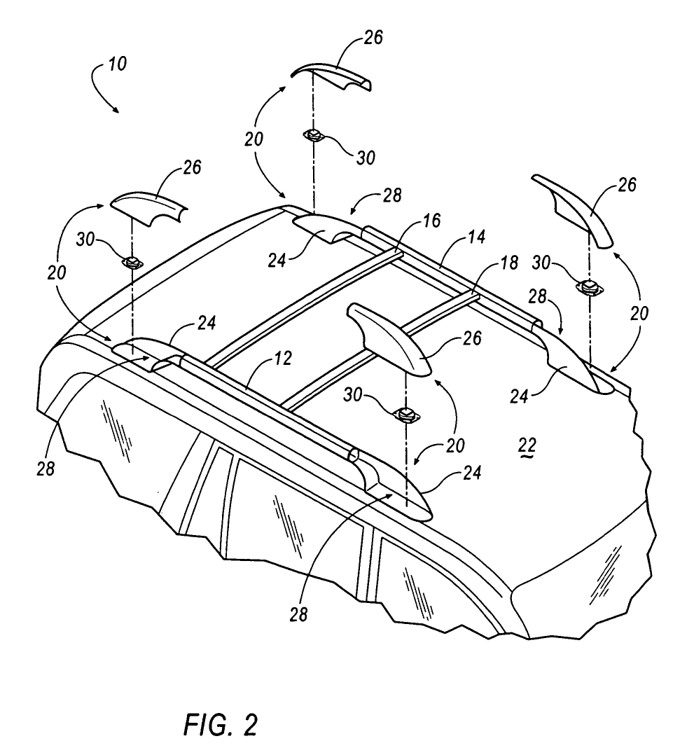

The above-described disadvantages are overcome and a number of advantages are realized by an inventive article carrier, which is shown generally at 10 in FIGS. 1 and 2. As illustrated, the article carrier 10 include side rails 12, 14 and cross rails 16, 18. Pairs of end cap structures 20 are secured to the vehicle roof 22. The end cap structures 20 elevate and provide support for the side rails 12, 14.

Referring to FIG. 2, each end cap structure 20 includes a fixed portion 24 and a removable portion 26. The fixed portion 24 is secured to the vehicle roof 22 and is attached to the side rail 12, 14. The removable portion 26 may be snap fit, locked, or secured to the fixed portion 24 in any desirable manner. When the removable portion 26 is attached to the fixed portion 24, a cavity 28 is defined for housing an antenna element 30. Although four end cap structures 20 and four associated antenna elements 30 are shown, it will be appreciated that any desirable number of end cap structures 20, antenna elements 30, or side rails 12, 14 may be incorporated into the design of the article carrier 10.

The end cap structure 20 includes a thermoplastic material that permits reception and transmission of signals, S (FIG. 1), to and from the antenna element 30. For example, the end cap structure 20 may include polycarbonate-Acrylonitrile-Butadiene-Styrene (PC/ABS). The thermoplastic material that is used to form the end cap structure 20 is commercially available from General Electric Corporation of New York, N.Y., and is sold under the trade-name GELOY®. According to an embodiment, the signals, S, may be terrestrial signals, or, as shown in FIG. 1, high frequency signals from a satellite 75. The frequency of the signals, S, may range, for example, between approximately 540-1700 kHz (i.e. the AM frequency range), 88.1-107.9 MHz (i.e. the FM frequency range), 824-894 MHz (i.e. the AMPS frequency range), 1563-1587 MHz (i.e. the GPS frequency range), 1850-1990 MHz (i.e., the PCS frequency range), 2320-2345 MHz (i.e. the SDARS frequency range), or the like.

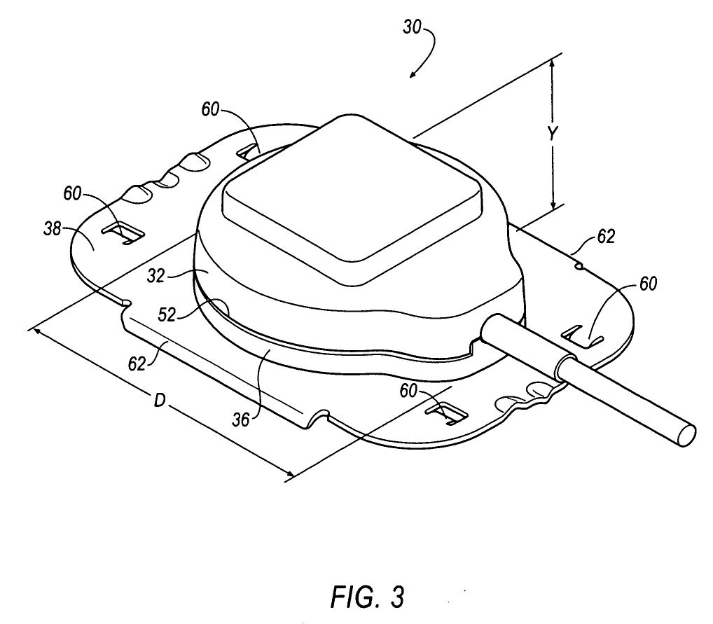

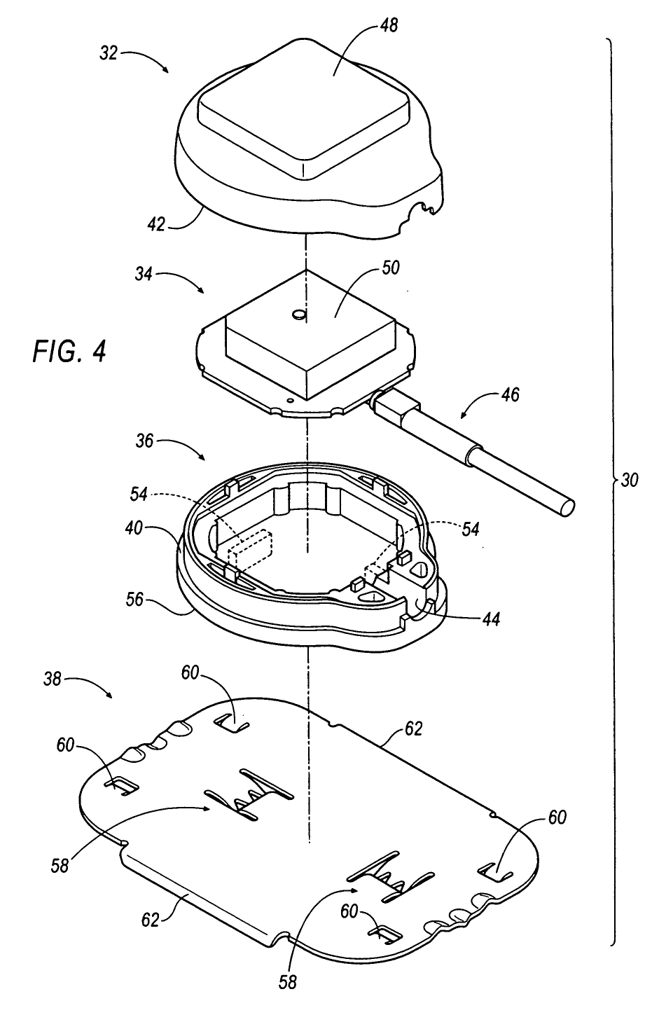

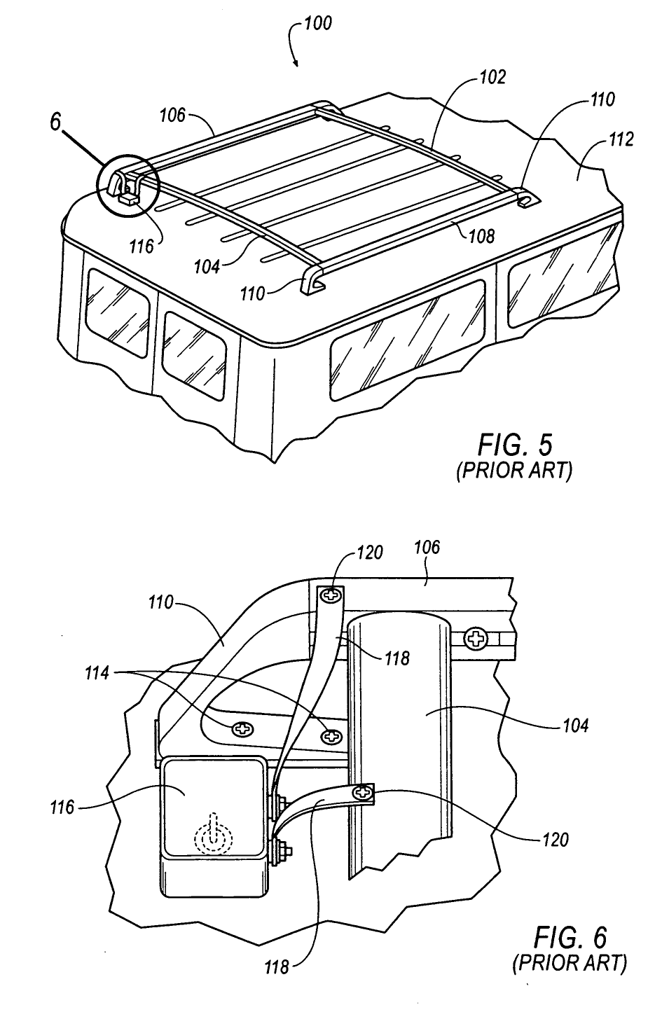

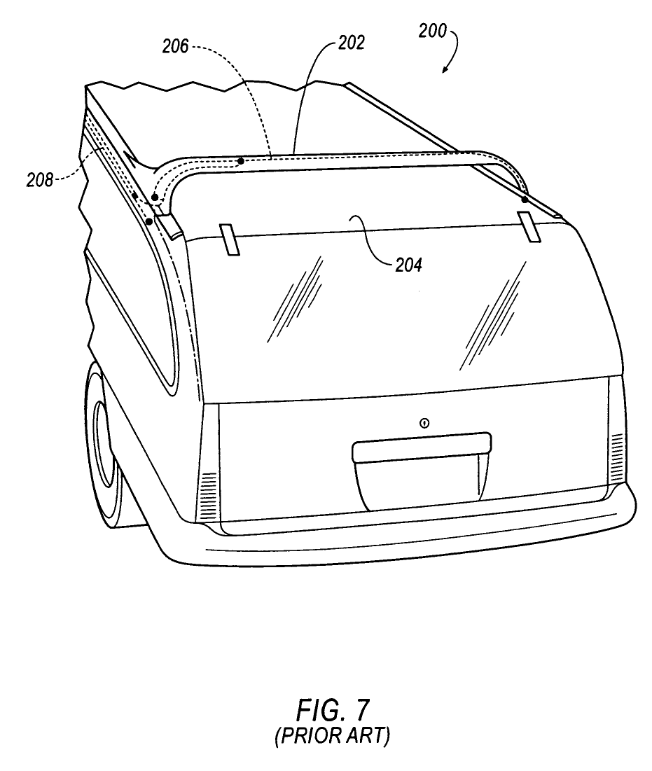

Referring to FIGS. 3 and 4, the antenna element 30 generally comprises a cover portion 32, a circuit board assembly 34, a case 36, and an optional metal ground plane 38. The ground plane 38 may be an optional element if the vehicle roof 22 does not comprise a metallic material. The cover portion 32 may include any desirable thermoplastic material and may be formed using any desirable method, such as injection molding. The case 36 is a conductive enclosure including a metal-impregnated thermoplastic resin, such as, for example, PC/ABS, and may also be formed, for example, by injection molding. As illustrated, the case 36 encloses the circuit board assembly 34. The metal elements impregnated in the PC/ABS may include, for example, nickel plated graphite fibers and/or carbon fiber segments, and be in the form of pellets, shavings, or fibers that are mixed with the PC/ABS material prior to the injection molding operation. According to another embodiment, the case 36 may include a conductive paint applied to a thermoplastic case. Alternatively, in yet another embodiment, the case 36 may include a metal-formed “can” enclosure that may be applied to a, thermoplastic case. When the antenna element 30 is activated, the metal elements in the case 36 provide a capacitive coupling between the circuit board assembly 34 and the vehicle roof 22 or ground plane 38.

As shown in FIG. 4, the circuit board assembly 34 is received by the case 36. The case 36 also includes a peripheral flange 40 that receives a bottom periphery 42 of the cover portion 32. The case 36 also includes a passage 44 for permitting extension of a cable 46 from the circuit board assembly 34. The cable 46 may be extended through the vehicle roof 22 to electronics within the vehicle. However, it will be appreciated that the cable 46 may be eliminated and the antenna element 30 may be electromagnetically coupled to communicate signals through the vehicle roof 22 so that a passage does not have to be provided in the vehicle roof 22 for the cable 46. The cover portion 32 is shaped to include an embossed portion 48 for receiving a low noise amplifier and patch antenna element 50 of the circuit board assembly 34. When placed over the peripheral flange 40 of the case 36, the cover portion 32 encapsulates the circuit board assembly 34.

Once assembled as shown in FIG. 3, the peripheral flange 40 of the case 36 is ultrasonically welded to the bottom periphery 42 of the cover portion 32 to define a welded seam 52, which seals the circuit board assembly 34 from contaminates and the like. In an alternative embodiment, frictional snaps, or other types of fastening devices, may be used in conjunction with a perimeter gasket to hold together and seal the assembly. The antenna element 30, may generally include a diameter, D, approximately equal to 35.0 mm and a height, Y, approximately equal to 12.5 mm.

If the ground plane 38 is incorporated with the antenna element 30, the case 36 may include a pair of integrated fastening portions 54 (FIG. 4) that extend from a bottom portion 56 of the case 36 for reception at receiving portions 58 in the ground plane 38. The ground plane 38 may further comprise a plurality of resilient tabs 60 and/or guide flanges 62 for securing the antenna element 30 to a structural element, such as the fixed portion 24 of the end cap structure 20 or the vehicle roof 22. If the ground plane 38 is not incorporated with the antenna element, the case 36 may be adhesively secured to the fixed portion 24 of the end cap structure 20 or vehicle roof 22; alternatively, the case 36 may include similar resilient tabs and/or guide flanges as similarly shown with the ground plane 38.

Referring to FIGS. 1 and 2, a plurality of antenna elements 30 are shown within the article carrier 10 for implementation in a diversity application where the plurality of antennas elements 30 are utilized to improve antenna performance. As is known in the art, if a first antenna in a diversity application loses reception of an expected signal, the diversity application will poll the other antennas in the application for expected signal reception so that the diversity system will switch to a different antenna that is receiving the expected signal while the reception of the expected signal by the first antenna is temporarily unavailable. Because the article carrier 10 extends generally from a front to rear portion of the vehicle roof 22, the antenna elements 30 may be spaced apart at multiple locations on the vehicle roof 22 for optimized expected signal reception in the diversity application.

Accordingly, the article carrier 10 provides a dual function as a roof rack for stowing articles, such as luggage, while also providing structure for concealing one or more antenna elements 30 in a “hidden antenna” system. Because the antenna elements 30 include a relatively small patch antenna element 50, the antenna elements 30 are optimally sized for being housed in a hidden antenna system within the article carrier 10. As such, because the antenna elements 30 are hidden from sight within the article carrier 10, an aesthetically-pleasing look to the vehicle is thereby maintained. Additionally, because each end cap structure 20 includes a removable portion 26, the antenna elements 30 may be easily serviced due to the simplified structure of the end caps 20 of the article carrier 10. Even further, because the article carrier 10 may house multiple antenna elements 30, signal reception may be maintained in a diversity application.

Although the illustrated embodiments of the article carrier 10 show a removable portion 26 of an end cap structure 20, it will be appreciated that a fixed portion and a removable portion may be included in any desirable structural element of the article carrier 10, such as, for example, the side rails 12, 14 and/or cross rails 16, 18 such that the antenna elements 30 may be housed within a cavity of any of the rails 12-18. Even further, it will be appreciated that structures other than an article carrier 10, such as, for example, a spoiler, a third brake light housing, or a tail lamp, may include a fixed portion and a removable portion for housing an antenna element 30 in a hidden antenna application.

While the invention has been specifically described in connection with certain specific embodiments thereof, it is to be understood that this is by way of illustration and not of limitation, and the scope of the appended claims should be construed as broadly as the prior art will permit.

What is claimed is:

1. A hidden antenna system comprising:
an external vehicle component including a removable portion attached to a fixed portion that defines a cavity; and
an antenna element that is housed within the cavity.

2. The hidden antenna system according to claim 1, wherein the external vehicle component is an article carrier, spoiler, third brake light housing, or tail lamp.

3. The hidden antenna system according to claim 1, wherein the the external vehicle component includes an end cap structure, wherein the end cap structure includes the fixed portion and the removeable portion.

4. The hidden antenna system according to claim 3, wherein the external vehicle component includes at least one side rail, wherein the fixed portion of the end cap structure is connected to the at least one side rail.

5. The hidden antenna system according to claim 3, wherein the end cap structure includes a thermoplastic material that permits reception and transmission of terrestrial and/or satellite signals to and from the antenna element housed within the cavity.

6. The hidden antenna system according to claim 5, wherein the thermoplastic material includes PC/ABS.

7. The hidden antenna system according to claim 5, wherein the signals include a frequency range of approximately 824-894 MHz, 1563-1587 MHz, 1850-1990 MHz, or 2320-2345 MHz.

8. A hidden antenna system comprising:
an article carrier including a first and second end cap structure that elevates and supports a side rail over a vehicle roof, wherein the first and second end cap structure each includes a removable portion attached to a fixed portion that defines a first and second cavity, respectively, of the first and second end cap structure; and
a first and second antenna element that are housed, respectively, within the first and second cavity.

9. The hidden antenna system according to claim 8, wherein the first and second end cap structure includes a thermoplastic material that permits reception and transmission of terrestrial and/or satellite signals to and from the first and second antenna elements housed within the first and second cavity.

10. The hidden antenna system according to claim 9, wherein the thermoplastic material includes PC/ABS.

11. The hidden antenna system according to claim 9, wherein the signals include a frequency range of approximately 824-894 MHz, 1563-1587 MHz, 1850-1990 MHz, or 2320-2345 MHz.

12. The hidden antenna system according to claim 8, wherein the first and second antenna elements operate in a diversity application.

13. A hidden antenna system comprising:
an article carrier including a first and second cavity; and
at least two antenna elements that are housed, respectively, within the first and second cavities, wherein the at least two antennta elements operate in a diversity application.

14. The hidden antenna system according to claim 13, wherein the the article carrier includes first and second end cap structures, wherein the first and second end cap structures each include a fixed portion and a removeable portion that define the at least first and second cavities.

15. The hidden antenna system according to claim 14, wherein the article carrier includes at least one side rail, wherein the fixed portion of the first and second end cap structures are connected to the at least one side rail.

16. The hidden antenna system according to claim 14, wherein the first and second end cap structures include a thermoplastic material that permits reception and transmission of terrestrial and/or satellite signals to and from the antenna element housed within the at least first and second cavities.

17. The hidden antenna system according to claim 16, wherein the thermoplastic material includes PC/ABS.

18. The hidden antenna system according to claim 16, wherein the signals include a frequency range of approximately 824-894 MHz, 1563-1587 MHz, 1850-1990 MHz, or 2320-2345 MHz.
